(19) United States
(12) Patent Application Publication
(10) Pub. No.: US 2005/0288003 A1
(43) Pub. Date: Dec. 29, 2005

(54) Wireless communication system and communication terminal

(75) Inventor: Masafumi Matsumura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/086,228

(22) Filed: Mar. 23, 2005

(30) Foreign Application Priority Data
Jun. 29, 2004 (JP) 2004-192054

(51) Int. Cl. H04M 1/00

(52) U.S. Cl. 455/418; 455/552.1

(57) ABSTRACT

The communication apparatus is provided with two different wireless communication methods, namely I/F for LAN and I/F for PAN. The communication quality recognition section recognizes a communication quality in each of two wireless communication methods and the communication interface control section selects the communication method with superior communication quality.

The present application is based on Japanese patent application No. 2004-192054, the entire contents of which are incorporated herein by reference.

### BACKGROUND OF THE INVENTION

1. Field of the Invention

The present invention relates to a wireless communication system and a wireless communication apparatus that communicate by radio between electronic apparatuses and in particular, to a wireless communication system that can switch a communication method depending on communication circumstances and a communication terminal equipped with the same wireless communication system.

2. The Related Art of the Invention

There are rapidly increasing demands for communication between computers due to recent popularization of the internet. Further, it is desired that users can communicate using mobile personal computers anywhere without limit to use locations of personal computers.

Building a wired LAN in a company or a school enables communication at locations other than a user' desk therein only if a LAN terminal is provided. Further, owing to progress of wireless LAN technologies, communications are possible anywhere within the reach of radio waves without any terminal. With regard to standards of wireless communications, a plurality of standards such as IEEE 802.15.3a/b/g among wireless LANs exist and in addition, technologies and standards such as Bluetooth (registered trademark) or a PAN (Personal Area Network) come in the world. Some of mobile personal computers carry some of a plurality of the communication standards. However, selection about which standard is used requires a user's operation.

In order to cope with these problems, for example, Japanese Unexamined Patent Publication No. 2003-229790 has disclosed a communication system that can automatically switch from a wireless LAN to a wired LAN and vise versa.

The invention of the above Patent Publication, however, relates only to the switching between the wireless and wired communication methods. Therefore, a user using a mobile personal computer equipped with a plurality of communication methods needs to select a wireless communication system available under the circumstance in use of the mobile personal computer and perform setting alternations thereof on its own and then, communicate with the other party.

In view of the above, there exists a need for a wireless communication system and a wireless communication terminal which overcome the above-mentioned problems in the related art.

The present invention addresses this need in the related art and also other needs, which will become apparent to those skilled in the art from this disclosure.

### SUMMARY OF THE INVENTION

It is an object of the present invention to provide a wireless communication system and a wireless communication terminal that can automatically select an optimal wireless communication method out of a plurality of wireless communication methods and switch to the selected method.

According to a first aspect of the present invention, a wireless communication system comprises, a first communication terminal, a second communication terminal to perform wireless communication with the first communication terminal by at least two different wireless communication methods, wherein the first communication terminal comprises, a recognition section that recognizes a wireless communication state in each of at least the two different wireless communication methods with the second communication terminal, a selection section that selects a communication method with a higher communication rate out of at least the two different wireless communication methods, and wherein the first communication terminal performs the selected communication method and the second communication terminal performs the wireless communication with the first communication terminal by the selected wireless communication method by the first communication terminal.

The first communication terminal may preferably be a mobile communication terminal and the second communication terminal may preferably be a stationary communication terminal.

The first communication terminal may preferably be a mobile personal computer and the second communication terminal may preferably be a television.

The mobile personal computer and the television may preferably be provided with a transmission/reception antenna respectively.

The first and second communication terminals may preferably perform the wireless communication based upon communication standards of wireless LAN and PAN.

According to a second aspect of the present invention, a communication terminal comprises a wireless communication section that performs wireless communication with at least two different wireless communication methods, a recognition section that recognizes a communication state of the wireless communication in each of at least the two different wireless communication methods with another communication terminal, a selection section that selects a wireless communication method with a higher communication rate out of at least the two different wireless communication methods.

The wireless communication section may preferably comprise a first wireless communication section that performs the wireless communication based upon a communication standard of wireless LAN as one of at least the two different wireless communication methods, and a second wireless communication section that performs the wireless communication based upon a communication standard of PAN as the other.

The recognition section may preferably notify the another communication terminal that it is impossible to perform the wireless communication by the PAN.

The selection section may preferably select an appropriate communication method out of at least the two different wireless communication methods based upon at least one of a communication distance and communication quality recognized by the recognition section.

The selection section may preferably select an appropriate communication method out of at least the two different wireless communication methods based upon a distance between the communication terminal and the another communication terminal recognized by the recognition section.

According to a third aspect of the present invention, a wireless communication system comprises, a first communication terminal, a second communication terminal to perform wireless communication with the first communication terminal by at least two different wireless communication methods, wherein the first communication terminal comprises, a recognition section that recognizes a wireless communication state in each of at least the two different wireless communication methods with the second communication terminal, the recognition section comprising, a communication quality recognition section that recognizes communication quality information of at least the two different wireless communication methods and a distance information recognition section that recognizes a distance information of one of at least the two different wireless communication methods, a selection section that receives the communication quality information and the distance information from the recognition section to select a communication method with a higher communication rate out of at least the two different wireless communication methods, and wherein the first communication terminal performs the selected communication method and the second communication terminal performs the wireless communication with the first communication terminal by the selected wireless communication method by the first communication terminal.

The first communication terminal may preferably be a mobile communication terminal and the second communication terminal may preferably be a stationary communication terminal.

The first communication terminal may preferably be a mobile personal computer and the second communication terminal may preferably be a television.

The communication quality recognition section may preferably be connected to I/F for LAN and I/F for PAN to receive the communication quality information and the distance information, and the distance information recognition section may preferably be connected to the I/F for PAN to receive the distance information.

According to a fourth aspect of the present invention, a communication terminal comprises, a wireless communication section that performs wireless communication with at least two different wireless communication methods, a recognition section that recognizes a communication state of the wireless communication in each of at least the two different wireless communication methods with another communication terminal, the recognition section comprising, a communication quality recognition section that recognizes communication quality information of at least the two different wireless communication methods and a distance information recognition section that recognizes a distance information of one of at least the two different wireless communication methods, a selection section that receives the communication quality information and the distance information from the recognition section to select a communication method with a higher communication rate out of at least the two different wireless communication methods.

The wireless communication section may preferably comprise a first wireless communication section that performs the wireless communication based upon a communication standard of wireless LAN as one of at least the two different wireless communication methods, and a second wireless communication section that performs the wireless communication based upon a communication standard of PAN as the other.

The recognition section may preferably notify the another communication terminal that it is impossible to perform the wireless communication by the PAN.

The selection section may preferably select an appropriate communication method out of at least the two different wireless communication methods based upon at least one of a communication distance and communication quality recognized by the recognition section.

The selection section may preferably select an appropriate communication method out of at least the two different wireless communication methods based upon a distance between the communication terminal and the another communication terminal recognized by the recognition section.

According to a fifth aspect of the present invention, a wireless communication terminal comprises: a communication function section comprising a wireless communication section that performs wireless communication with at least two different wireless communication methods, a recognition section that recognizes a communication state of the wireless communication in each of at least the two different wireless communication methods with another communication terminal, and a selection section that selects a wireless communication method with a higher communication rate out of at least the two different wireless communication methods; and a communication apparatus main body detachably connected to the communication function main body, the communication apparatus main body comprising a data storage section that stores data from the communication function section, and a display section that displays the data.

### ADVANTAGES OF THE INVENTION

From what is stated above, it is obvious that the following excellent advantages can be achieved according to the present invention.

In an electronic apparatus that performs a plurality of wireless communication methods, an optimal wireless communication method can be automatically selected even if a user has the difficulty of judging which wireless communication method is appropriate, thereby to maintain a stable communication.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

The preferred embodiments according to the invention will be explained below referring to the drawings, wherein:

FIG. 1 is a perspective view showing an example to which a wireless communication system in a preferred embodiment according to the present invention is applied;

FIG. 2A is a constitutional view showing a wireless communication apparatus of a wireless communication system in the preferred embodiment according to the present invention;

FIG. 2B is a constitutional view showing a wireless communication apparatus in a modification of the preferred embodiment where a constitutional section with regard to a communication function is separated as a PC card from a communication apparatus main body;

FIG. 3 is an example showing apparatus information stored in an apparatus information storage section of the wireless communication apparatus of the wireless communication system;

FIG. 4 is a table showing an example of control commands and data constituting communication data used in the wireless communication system in the preferred embodiment according to the present invention;

FIG. 5 is a view showing a state of transmission/reception of control commands between the wireless communication apparatuses of the wireless communication system;

FIG. 6 is a table showing an example of more detailed information with regard to communication speeds out of data contents constituting the communication data in FIG. 4;

FIG. 7 is a graph showing a relation in a communication range (distance) and a communication rate between LAN and PAN in the wireless communication system;

FIG. 8 is a flow chart showing steps in performing communication between the wireless communication apparatus in the preferred embodiment according to the present invention and a wireless communication apparatus of the other party;

FIG. 9 is a flow chart showing steps in switching a communication method from PAN to LAN due to deterioration of PAN communication quality during the PAN communication of the wireless communication system in the preferred embodiment according to the present invention;

FIG. 10 is a flow chart showing steps in switching a communication method from LAN to PAN due to improvement of PAN communication quality during the LAN communication of the wireless communication system in the preferred embodiment according to the present invention;

FIG. 11 is a flow chart showing steps in switching a communication method from PAN to LAN when it is recognized that a communication distance exceeds a distance appropriate for a PAN communication during the PAN communication of the wireless communication system in the preferred embodiment according to the present invention;

FIG. 12 is a flow chart showing steps in switching a communication method from PAN to LAN when it is recognized by the communication apparatus of the other party that a communication distance exceeds a distance appropriate for a PAN communication during the PAN communication of the wireless communication system in the preferred embodiment according to the present invention; and

FIG. 13 is a flow chart showing steps in switching a communication method from PAN to LAN when a communication circumstance of the LAN communication during the PAN communication of the wireless communication apparatus in the preferred embodiment according to the present invention becomes superior to a communication circumstance of the PAN communication.

### DETAILED DESCRIPTION OF THE PREFERRED EMBODIMENT

A wireless communication system and a communication terminal in a preferred embodiment according to the present invention will be explained as follows.

A wireless communication system in a preferred embodiment according to the present invention is an advantageous system in a case it is difficult to perform a wired communication during a plurality of electronic apparatuses, in particular when at least one of the plurality of the electronic apparatuses is a mobile.

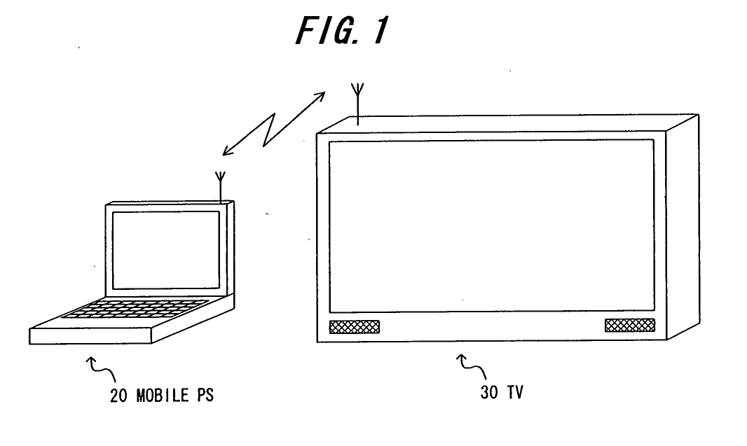

FIG. 1 is a perspective view showing an example to which a wireless communication system in a preferred embodiment according to the present invention is applied where a mobile personal computer (referred to as PC hereinafter) 20 as a first communication terminal is connected to a television (referred to as TV hereinafter) 30 by an preferred embodiment of the present invention, which allows to display information stored in the PC 20 on the TV 30 or to transfer information received/stored in the TV 30 to the PC 20.

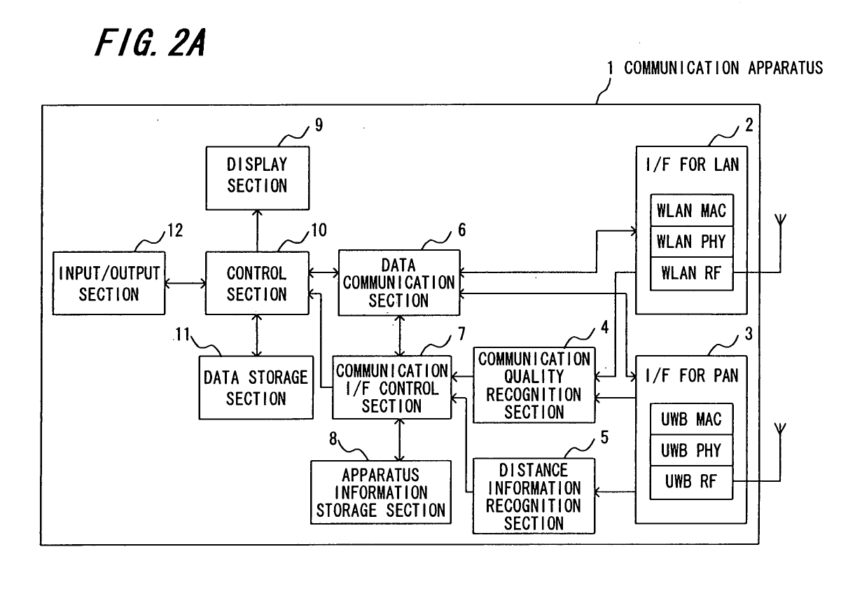

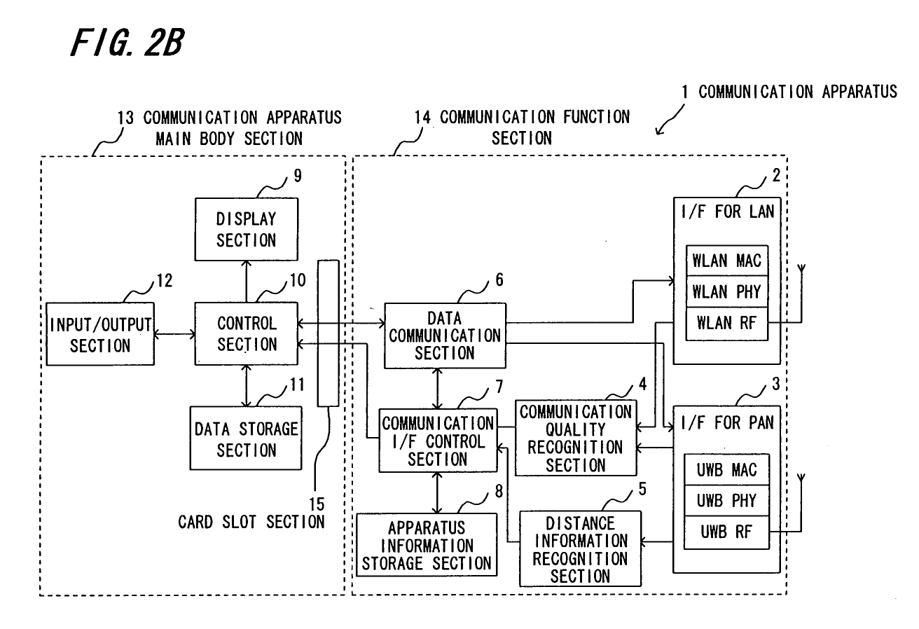

FIG. 2A is a constitutional view showing a wireless communication apparatus of a wireless communication system in the preferred embodiment according to the present invention. The preferred embodiment uses two kinds of communication methods such as wireless LAN and PAN, but the present invention is not limited thereto and may use Blue tooth (registered trademark) instead of these methods, wireless LANs of different methods, or switch three or more methods as a communication method. A communication apparatus 1 controlled by the wireless communication system in the preferred embodiment according to the present invention includes an interface (I/F) 2 for LAN and an I/F 3 for PAN, and enables communication with a communication apparatus of the other party through these I/Fs. The communication apparatus of the other party is, in FIG. 1, TV 30 to PC 20, or PC 20 to TV 30. LAN and PAN in the following explanation mean respectively wireless LAN and wireless PAN.

Each of the I/F 2 for LAN and the I/F 3 for PAN is connected to a communication quality recognition section 4, which recognizes a communication quality of each of them.

And the I/F 3 for PAN is also connected to a distance information recognition section 5, whereby it is recognized whether or not a distance between the communication apparatus 1 and the communication apparatus of the other party is within a distance enabling communication therebetween by PAN.

Further, each of the I/F 2 for LAN and the I/F 3 for PAN is connected to a data communication section 6, which controls a protocol for communications and actual communications.

And each of the communication quality recognition section 4 and the distance information recognition section 5 is connected to a communication interface control section 7, which selects the best communication method based upon the communication quality in each communication method recognized by the communication quality recognition section 4, and the communication distance of PAN recognized by the distance information recognition section 5.

And the communication interface control section 7 is also connected to an apparatus information storage section 8, which stores communication capability information with regard to the I/F 2 for LAN or the I/F 3 for PAN, authentication information for connection of the communication apparatus 1, and communication capability information or authentication information of the communication of the other party.

Further, the communication interface control section 7 is also connected to a data communication section 6 to transmit information with regard to the best communication method selected by the communication interface control section 7 to the data communication section 6 and the data communication section 6 that has received the information receives data from the I/F in relation to the communication method selected based upon the information.

And the communication apparatus 1 is also provided with a display section 9, which displays information or the like that the communication apparatus 1 receives/transmits through communication.

The communication apparatus 1 is also provided with a control section 10, namely CPU which performs control of the communication apparatus 1. The information which is judged to be displayed to users by the control section 10 is displayed by a display section 9 connected to the control section 10.

The control section 10 is connected to a data storage section 11, which stores programs to actuate the communication apparatus 1 or various kinds of information, such as ROM, RAM, and HDD.

The control section 10 is also connected to an input/output section 12, which is used for inputting information to the communication apparatus 1 with a keyboard or a mouse by a user, or for taking out information desired by a user to FDD or a removal storage and using it.

It is noted that the communication apparatus 1 in FIG. 2A includes the distance information recognition section 5, but it is not limited thereto, and may not include the distance information recognition section 5.

And it is explained that FIG. 2A shows an communication apparatus where respective components of the above-mentioned communication system are integral, but it is assumed that in a communication apparatus for a personal computer or the like a constituting section with regard to communication functions is separated as a PC card, namely a separate apparatus from a main body function section. FIG. 2B shows an example of such constitution.

FIG. 2B shows the communication apparatus 1 that a communication apparatus main body 13 and a communication function section 14 to be connected thereto. The communication apparatus main body section 13 corresponds to a PC main body or a TV main body, and the communication function section 14 corresponds to a PC card. The communication apparatus main body 13 and the communication function section 14 are detachably connected through a card slot section 15. A function of each constituting section thereof is the same as in FIG. 2A.

A detail of each constituting section will be explained as follows. The communication apparatus 1 is provided with two communication interfaces as the I/F 2 for LAN and the I/F 3 for PAN. In general an I/F for LAN can perform communication in a more extensive range as compared to an I/F for PAN and on the other hand, performs communication at a slower speed than the I/F for PAN such as UWB (Ultra Wideband).

In fact in case it is assumed that a communication interface such as IEEE802.11a/b/g/n is used as LAN and a communication interface of UWB such as IEEE802.15.3 is used as PAN, the former can assume such a communication capability as 100 Mbs or less within a radius of 100 m and the latter can assume such a communication capability as approximately maximum 500 Mbs within a radius of 10 m or less.

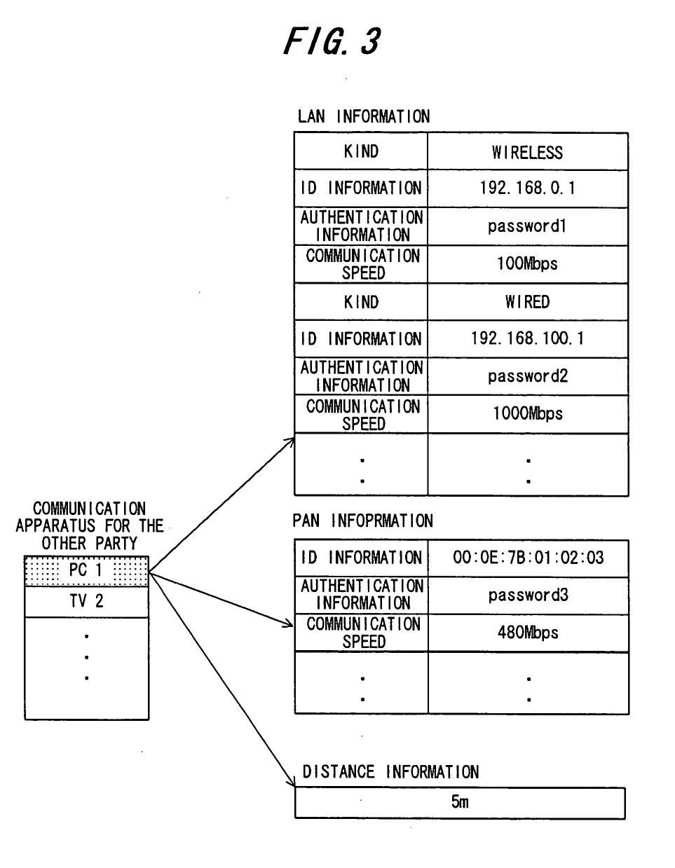

FIG. 3 is an example showing apparatus information stored in an apparatus information storage section 8 of the wireless communication apparatus 1 of the wireless communication system.

The communication apparatus 1 mutually exchanges communication capabilities with the other communication apparatus when connected with the other communication apparatus, whereby each of the communication apparatuses recognizes the kind and the number of the communication interfaces that both apparatuses include with each other. The information recognized at this time is stored in the apparatus information storage section 8 and then, the stored data is used in subsequent communications. The stored data include the information such as ID specific for an apparatus, a password for authentication, and a communication rate necessary for connection of LAN and PAN.

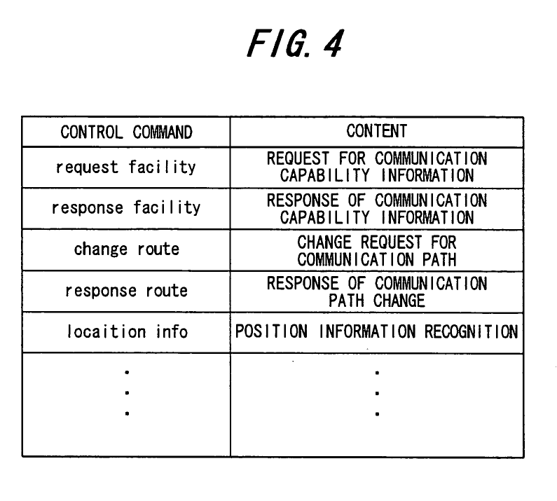

FIG. 4 is a table showing two classified information as control commands and data. The data communicated between communication apparatuses are classified as two data, namely control commands and data. The control commands are transmitted /received through the data communication section 6 to and from the I/F 2 for LAN by the communication interface control section 7, and the data are transmitted/received to and from the I/F 2 for LAN or the I/F 3 for PAN depending on a condition by controlling the data communication section 6 by the communication interface control section 7. For example, in case a user desires to communicate between communication apparatuses, the communication interface control section 7 transmits a control command to obtain communication capabilities of the other communication apparatus, while notifies the other communication apparatus of the communication capabilities of its own.

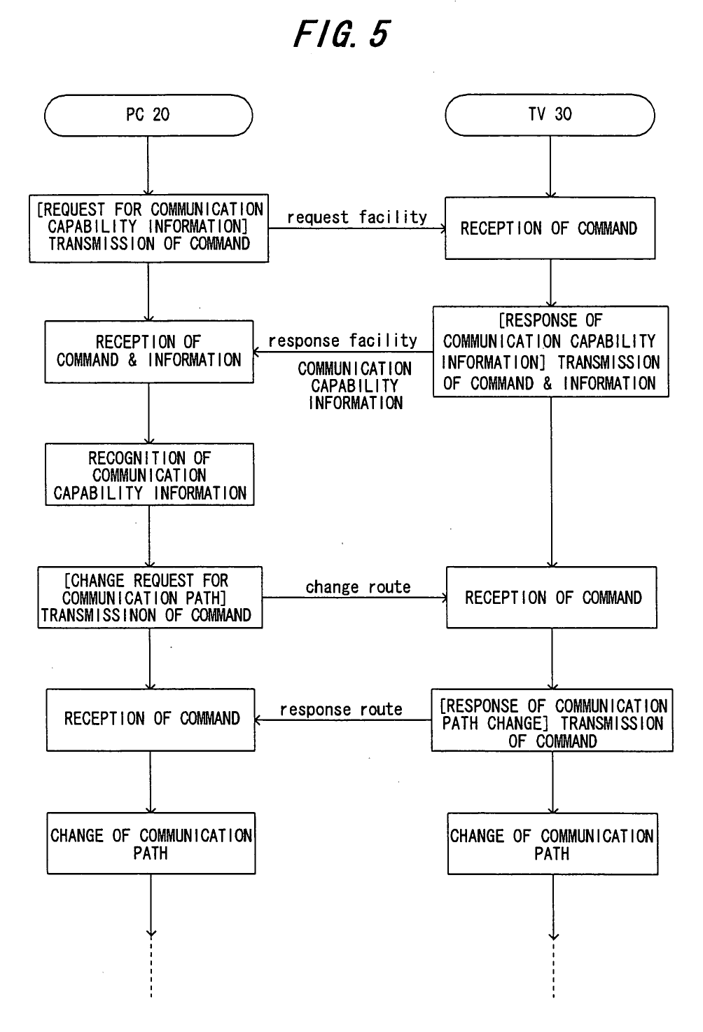

FIG. 5 is a view showing in a pattern diagram a state of transmission /reception of control commands between the wireless communication apparatuses of the wireless communication system. That is to say, FIG. 5 shows an example of wireless communications between the PC 20 and TV 30. First, the PC 20 transmits a command “request for communication capability information” through LAN to TV 30. The TV 30 that has received the command transmits a command “response of communication capability information” according to the command data, as well as the information with regard to communication capabilities of TV 30 to PC 20. The PC 20 that has received the command and the information recognizes the information and further stores the information in the apparatus information storage section 8.

Next, in the case of changing a communication path from LAN to PAN, the PC 20 transmits a command “request for change of communication path” to the TV 30. The TV 30 that has received the command transmits a command “response of change of communication path” to PC 20 according to the command data. The PC 20 that has received the command and the TV 30 that has transmitted the command change respective communication paths from LAN to PAN.

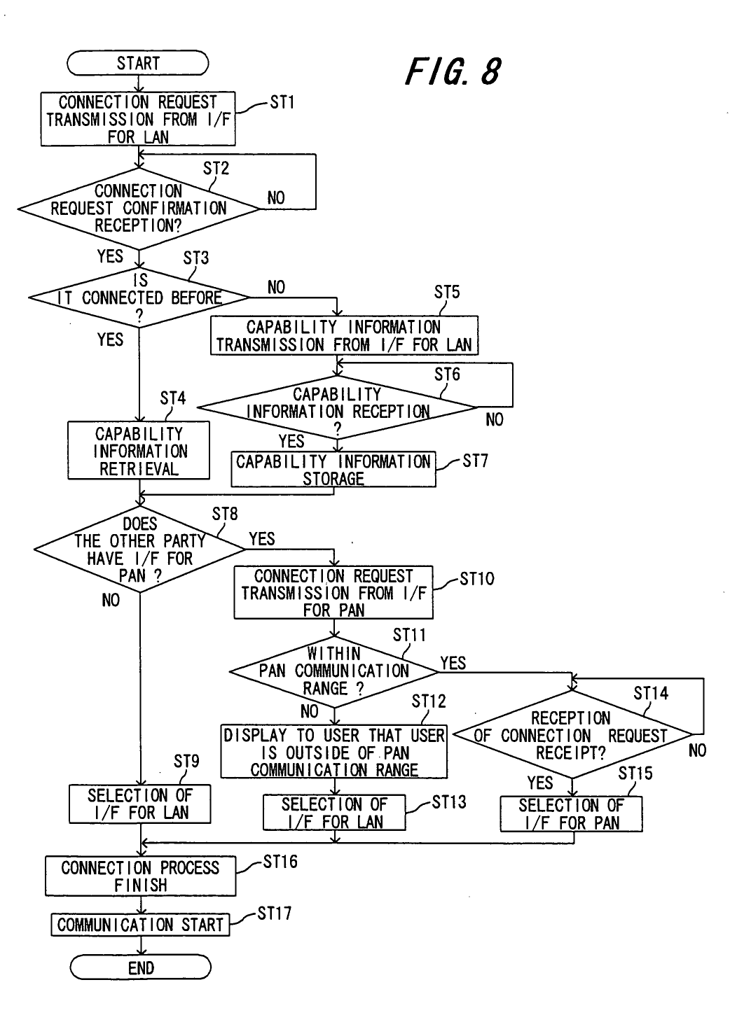

Since the wireless communication apparatus performs communication with the other wireless communication apparatus using LAN and PAN by transmission and reception of commands, a judgment whether or not the I/F 3 for PAN is used can be made between wireless communication apparatuses positioned inside or outside the communication range of PAN. And in case a communication apparatus a user desires to communicate with is outside the communication range of PAN, as well as a data transfer is difficult in communication bands of wireless LAN such as an image reproduction, the communication interface control section 7 can display a message “the apparatus can not be used due to being outside the communication range of PAN” on a display section 9 through a control section 10, and on the other hand, in case the data transfer is possible in the communication bands of the wireless LAN, a user can communicate using LAN as it is (refer to FIG. 8). A detail of this procedure will be described later.

And there is a case where the communication becomes impossible due to a user moving the communication apparatus during the communicating by the I/F 3 for PAN.

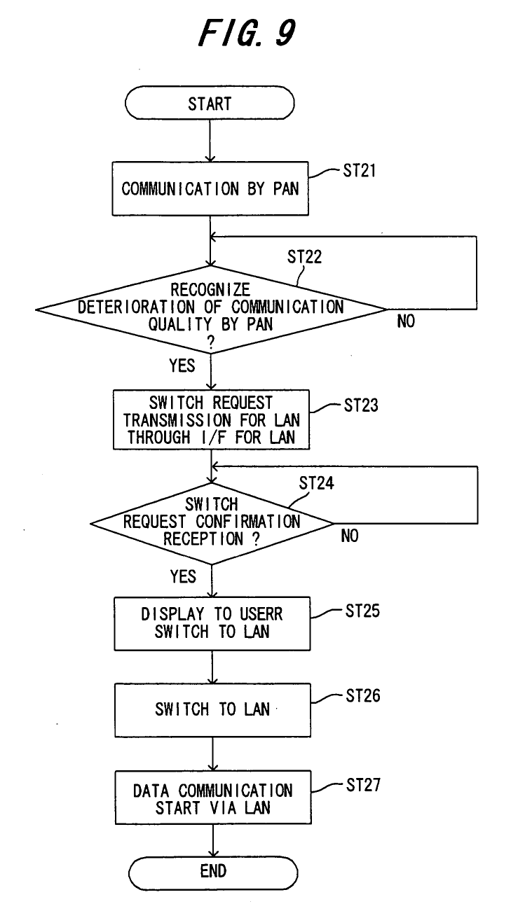

In order to avoid this problem, the communication interface control section 7 checks BER (Bit Error Rate) or PER (Packet Error Rate) of the data communicating through the I/F 3 for PAN by the communication quality recognition section 4 to recognize the communication quality. In the event the communication becomes difficult, the control command is transmitted through the I/F 2 for LAN as the other communication method to beforehand avoid stop of the data transfer (refer to FIG. 9). This procedure will be described later.

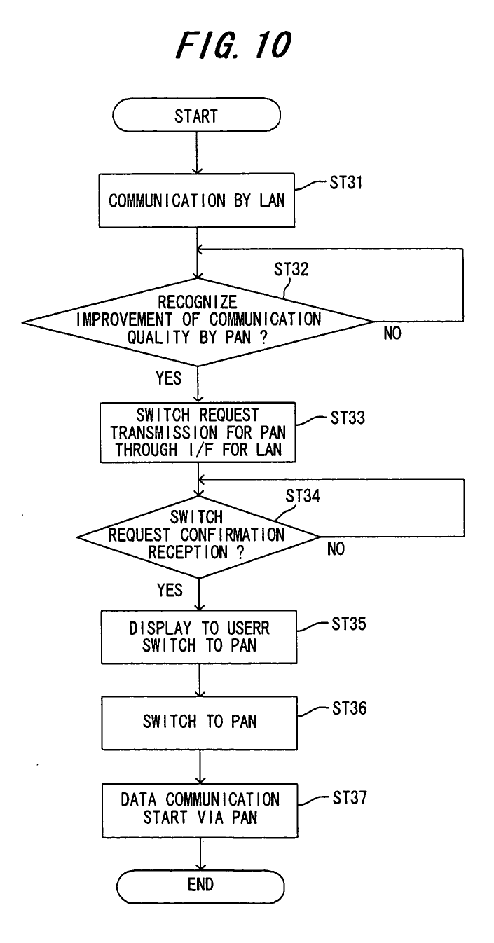

On the other hand, in case the communication is going on using the I/F 2 for LAN, if the communication interface control section 7 recognizes through the communication quality recognition section 4 that the communication by PAN becomes possible, the control command is transmitted through the I/F 2 for LAN to switch the communication method from LAN communication to PAN communication (refer to FIG. 10). This procedure will be described later.

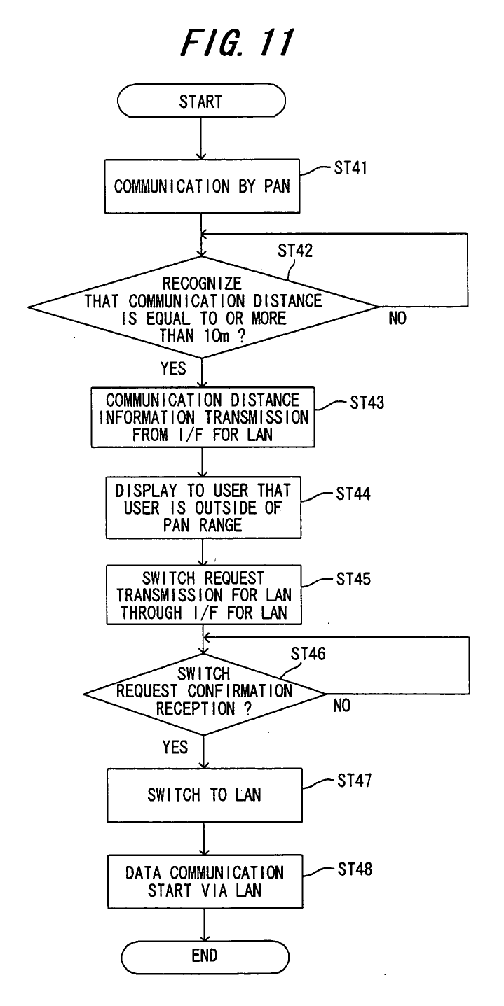

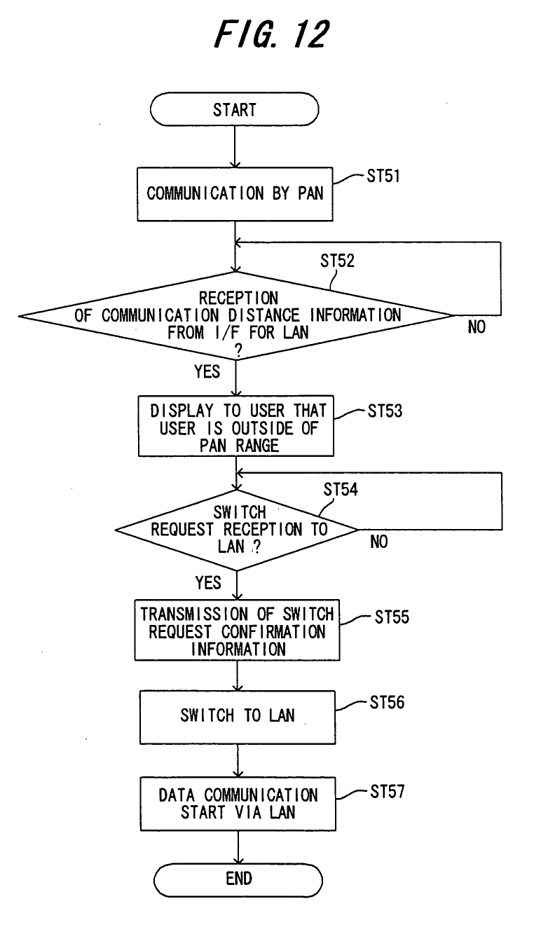

Further, whether or not the communication apparatus goes out of the communication range of PAN is determined based upon distance information recognized by the distance information recognition section 5. In the case of using UWB such as IEEE802.15.3 as PAN, in general a faster communication rate can be expected than a wireless communication LAN if the distance between the communication apparatuses is within 10 m. And when the UWB such as IEEE802.15.4 isused, it is possible to achieve the distance information recognition section 5 that recognizes the distance between the communication apparatuses communicating with each other. And if one of the communication apparatuses includes the distance information recognition section 5, the other can recognize it by the control command. Thereby the communication interface control section 7 can control the switching of LAN and PAN more accurately. And more detailed information can be displayed to a user (refer to FIGS. 11, 12).

And then, information with regard to communication speeds stored in the apparatus information storage section 8 is extended to add information with regard to communication distances.

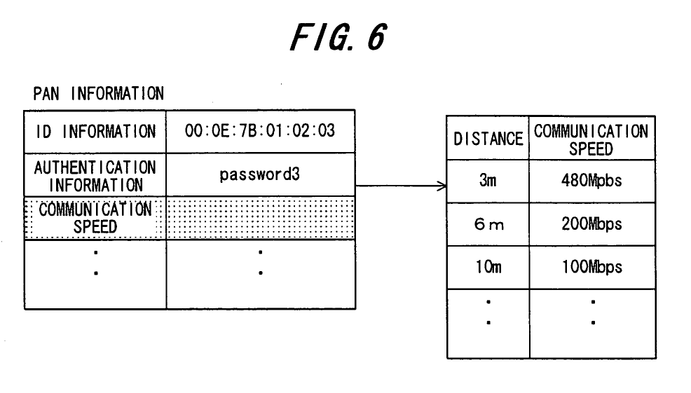

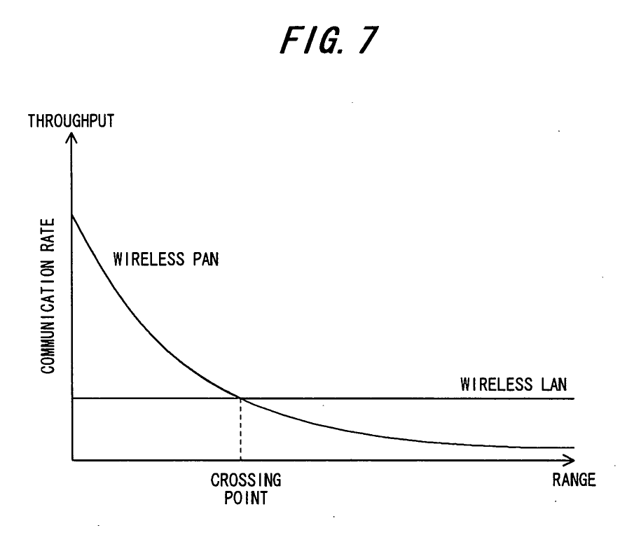

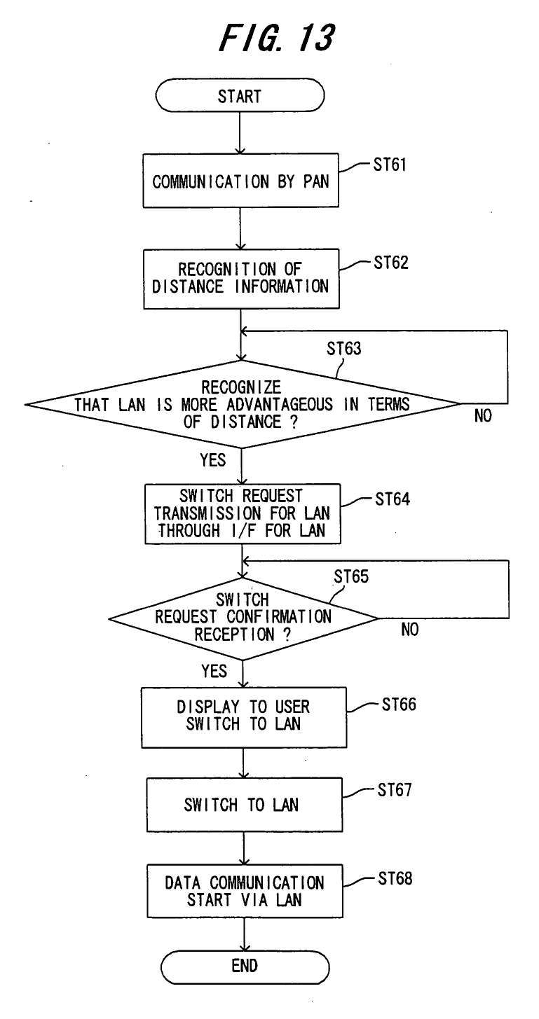

FIG. 6 is a view showing a state where the information with regard to the communication distances are added to the information with regard to the communication speeds out of the apparatus information stored in the apparatus information storage section 8 shown in FIG. 3. In actual LAN and PAN, as shown in FIG. 7, a communication rate of LAN shows substantially a constant value within a certain range (distance) and a communication rate of PAN rapidly lowers with extension of the distance. Therefore, a crossing point where each communication rate crosses over depends on the distance between the communication apparatuses. Accordingly the communication interface control section 7 can more accurately perform the switching between LAN and PAN based upon such extended data as shown in FIG. 6, as well as the distance information by the distance information recognition section 5 (refer to FIG. 13). A detail of this procedure will be described later.

Steps with regard to the switching of communication connections and communication methods in a communication system in the preferred embodiment according to the present invention will be explained with reference to the flow chart.

Communication switch steps to be explained as follows are performed by driving each constituting section based upon commands from the control section 10 according to programs stored in the data storage section 11.

FIG. 8 is a flow chart showing steps in connecting with a communication line of the communication apparatus of the other party at the beginning of communication.

First, the I/F 2 for LAN transmits a connection request data to the communication apparatus of the other party (ST1). And it is judged whether or not information to confirm that the communication apparatus of the other party has received the connection request data is received (ST2). In case it is judged that the information is not received (ST2: NO), this process is repeated, and in case it is judged that the information is received (ST2: YES), at the next step, it is judged whether or not the communication apparatus of the other party has been connected with this one before (ST3). In case the same information as the apparatus information transmitted does not exist in the stored apparatus information by comparing the apparatus information stored in the apparatus information storage section 8 as shown in FIG. 3 with the apparatus information of the communication apparatus of the other party included in the information transmitted from the communication apparatus of the other party (ST3: NO), it is judged that no connection with the communication apparatus of the other party has been made before, the process goes to ST5. On the other hand, in case the same information as the transmitted apparatus information exists in the stored apparatus information (ST3 :YES), it is judged that the connection therewith has been made before, and the information with regard to communication capabilities of the communication apparatus of the other party included in the apparatus information is retrieved (ST4).

On the other hand, in the process of ST5, the I/F 2 for LAN transmits a capability information request data to the communication apparatus of the other party (ST5). And it is judged whether or not the communication apparatus receives the capability information from the communication apparatus of the other party (ST6). In case it is judged that the capability information is not received (ST6: NO), this process is repeated, and in case it is judged that the capability information is received (ST6: YES), at the next step the apparatus information including the capability information obtained is stored in the apparatus information storage section 8 (ST7).

After the processes in ST4 and ST7, it is judged whether or not the communication apparatus of the other party is provided with the I/F 3 for PAN based upon the apparatus information of the communication apparatus of the other party (ST8). When it is judged that the communication apparatus of the other party is not provided with the I/F 3 for PAN (ST8: NO), since the communication is performed only by the wireless LAN, the I/F 2 for LAN is selected as the communication interface (ST9), and when it is judged that the communication apparatus of the other party is provided with the I/F 3 for PAN (ST8: YES), the connection request data is transmitted to the communication apparatus of the other party from the I/F 3 for PAN (ST10). And it is judged whether or not the communication apparatus of the other party is located within the communication range of PAN (ST11). When it is judged that the communication apparatus of the other party is not located within the communication range of PAN (ST11: NO), the information that the communication apparatus of the other party is not located within the communication range of PAN is notified a user through the display section 9 (ST12), and thereafter, the I/F 2 for LAN is selected as the communication interface (ST13). On the other hand, when it is judged that the communication apparatus of the other party is located within the communication range of PAN (ST11: YES), it is judged whether or not the information that the communication apparatus has received the connection request data from the communication apparatus of the other party is received (ST14). When it is judged that the information is not received (ST14: NO), the process is repeated, and When it is judged that the information is received (ST14: YES), at the next process the I/F 3 for PAN is selected as the communication interface (ST15).

After any one process of ST9, ST13, and ST15 is finished, the connection process is finished (ST16), and the communication with the communication apparatus of the other party is started (ST17).

FIG. 9 is a flow chart showing steps of switching the communication method from the I/F 3 for PAN to the I/F 2 for LAN when it becomes difficult to perform the communication by the I/F 3 for PAN due to quality deterioration of the PAN communication caused by an event that a user moves the communication apparatus during the communication through the I/F 3 for PAN.

First, the communication apparatus 1 is performing communication through the I/F 3 for PAN (ST21). And the communication quality recognition section 4 judges whether or not deterioration of the communication quality by PAN is recognized (ST22). When it is judged that no deterioration of the communication quality is recognized (ST22: NO), the process is repeated, and when it is judged that the deterioration of the communication quality is recognized (ST22: YES), the information of the switch request of the communication method for LAN communication is transmitted to the communication apparatus of the other party through the I/F 2 for LAN (ST23).

Next, it is judged whether or not the communication apparatus receives the confirmation information with regard to the switch request from the communication apparatus of the other party (ST24). When it is judged that the confirmation information is not received (ST24: NO), the process is repeated until it is judged that the confirmation information is received. When it is judged that the confirmation information is received (ST24: YES), the information to switch for LAN as the communication method is displayed on the display section 9 for a user (ST25).

Next, the interface for communication is switched from the I/F 3 for PAN to the I/F 2 for LAN by the data communication section 6 (ST26), and the data communication via LAN is started (ST27).

FIG. 10 is a flow chart showing steps of switching the communication method from the I/F 2 for LAN to the I/F 3 for PAN to when it becomes possible to perform the communication by the I/F 3 for PAN due to quality improvement of the PAN communication caused by an event that a user moves the communication apparatus during the communication through the I/F 2 for LAN.

First, the communication apparatus 1 is performing communication through the I/F 2 for LAN (ST31). And the communication quality recognition section 4 judges whether or not improvement of the communication quality by PAN is recognized (ST32). When it is judged that no improvement of the communication quality is recognized (ST32: NO), the process is repeated, and when it is judged that the improvement of the communication quality is recognized (ST32: YES), the information of the switch request of the communication method for PAN communication is transmitted to the communication apparatus of the other party through the I/F 2 for LAN (ST33).

Next, it is judged whether or not the communication apparatus receives the confirmation information with regard to the switch request from the communication apparatus of the other party (ST34). When it is judged that the confirmation information is not received (ST34: NO), the process is repeated until it is judged that the confirmation information is received. When it is judged that the confirmation information is received (ST34: YES), the information to switch for LAN as the communication method is displayed on the display section 9 for a user (ST35).

Next, the interface for communication is switched from the I/F 2 for LAN to the I/F 3 for PAN by the data communication section 6 (ST36), and the data communication via PAN is started (ST37)

The switch procedure shown in FIGS. 9 and 10 is the steps to switch the communication methods from PAN to LAN and from LAN to PAN in response to communication qualities in PAN. The preferred embodiment according to the present invention provides a communication apparatus that can switch communication methods from PAN to LAN and from LAN to PAN in response to distances between communication apparatuses. The switch procedure in this case will be shown in FIGS. 11 and 12.

FIG. 11 is a flow chart showing steps according to which the communication apparatus with the distance information recognition section 5 switches the communication method from the I/F 3 for PAN to the I/F 2 for LAN when the distance between the communication apparatuses exceeds the distance appropriate for the communication by PAN caused by an event that a user moves the communication apparatus during the communication through the I/F 3 for PAN. The distance appropriate for PAN communication is approximately 10 m and therefore, herein assumes 10 m as the basis.

First, the communication apparatus 1 is performing communication through the I/F 3 for PAN (ST41). And it is judged whether or not the distance information recognition section 5 recognizes that the communication distance to the communication apparatus of the other party reaches 10 m or more (ST42). When it is judged that the communication distance does not reach 10 m or more (ST42: NO), the process is repeated, and when it is judged that the communication distance reaches 10 m or more (ST42: YES), the information of the recognized communication distance is transmitted to the communication apparatus of the other party through the I/F 2 for LAN (ST43).

Next, after the information that the communication apparatus of the other party is not located within the communication range of PAN communication is displayed to a user through the display section 9 (ST44), the information of the switch request of the communication method for LAN communication is transmitted to the communication apparatus of the other party through the I/F 2 for LAN (ST45).

Next, it is judged whether or not the communication apparatus receives the confirmation information with regard to the switch request from the communication apparatus of the other party (ST46). When it is judged that the confirmation information is not received (ST46: NO), the process is repeated until it is judged that the confirmation information is received. When it is judged that the confirmation information is received (ST46: YES), the interface for communication is switched from the I/F 3 for PAN to the I/F 2 for LAN by the data communication section 6 (ST47), and the data communication via LAN is started (ST48).

FIG. 12 is a flow chart showing steps according to which the communication apparatus without the distance information recognition section 5 to perform communication with the communication apparatus with the distance information recognition section 5 switches the communication method from the I/F 3 for PAN to the I/F 2 for LAN when the distance between the communication apparatuses exceeds the distance appropriate for the communication by PAN caused by an event that a user moves the communication apparatus during the communication through the I/F 3 for PAN.

First, the communication apparatus 1 is performing communication through the I/F 3 for PAN (ST51). And it is judged whether or not the information of the communication distance that the communication distance to the communication apparatus of the other party reaches 10 m or more is received through the I/F 2 for LAN from the communication apparatus of the other party (ST52). When it is judged that the information of the communication distance is not received (ST52: NO), the process is repeated, and when it is judged that the information of the communication distance is received (ST52: YES), the information that the communication apparatus of the other party is not located within the communication range of PAN communication is displayed to a user through the display section 9 (ST53).

Next, it is judged whether or not the communication apparatus receives the information with regard to the switch request for LAN from the communication apparatus of the other party through the I/F 2 for LAN (ST54). When it is judged that the request information is not received (ST54: NO), the process is repeated until it is judged that the request information is received. When it is judged that the request information is received (ST54: YES), the communication apparatus 1 transmits through I/F 2 for LAN to the communication apparatus of the other party the information that the request information of the communication method for LAN communication is confirmed (ST57).

Next, the interface for communication is switched from the I/F 3 for PAN to the I/F 2 for LAN to by the data communication section 6 (ST56), and the data communication via LAN is started (ST57).

FIG. 13 is a flow chart showing steps according to which the communication is switched to the communication method through the I/F 2 for LAN when the LAN communication is superior to the PAN communication by comparing communication circumstances between the LAN and PAN communications even if the PAN communication is possible.

First, the communication apparatus 1 is performing communication through the I/F 3 for PAN (ST61). The distance information recognition section 5 recognizes the communication distance with the communication apparatus of the other party by PAN (ST62). Next, it is judged whether or not the communication distance is more advantageous for communication of LAN than of PAN based upon the recognized distance information (ST63). When it is judged that the continuous communication by PAN is more advantageous (ST63: NO), the process goes back to the process of ST62. When it is judged that the switching for communication of LAN is more advantageous (ST63: YES), the information of the switch request of the communication method for LAN communication is transmitted to the communication apparatus of the other party through the I/F 2 for LAN (ST64).

Next, it is judged whether or not the communication apparatus receives the confirmation information with regard to the switch request for LAN from the communication apparatus of the other party (ST65). When it is judged that the confirmation information is not received (ST65: NO), the process is repeated until it is judged that the confirmation information is received. When it is judged that the confirmation information is received (ST65: YES), the information that the communication method is switched for LAN communication is displayed to a user through the display section 9 (ST66).

Next, the interface for communication is switched from the I/F 3 for PAN to the I/F 2 for LAN by the data communication section 6 (ST67), and the data communication via LAN is started (ST68).

According to the steps described above, a wireless communication apparatus in a preferred embodiment of the present invention can automatically switch communication methods between LAN and PAN, whereby an optimal communication method at that point can be performed.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

1. A wireless communication system, comprising:
a first communication terminal; and
a second communication terminal to perform wireless communication with the first communication terminal by at least two different wireless communication methods, wherein:
the first communication terminal comprises;
a recognition section that recognizes a wireless communication state in each of at least the two different wireless communication methods with the second communication terminal; and
a selection section that selects a communication method with a higher communication rate out of at least the two different wireless communication methods, and wherein:
the first communication terminal performs the selected communication method; and
the second communication terminal performs the wireless communication with the first communication terminal through the selected wireless communication method by the first communication terminal.

2. The wireless communication system according to claim 1, wherein:
the first communication terminal is a mobile communication terminal and the second communication terminal is a stationary communication terminal.

3. The wireless communication system according to claim 1, wherein:
the first communication terminal is a mobile personal computer and the second communication terminal is a television.

4. The wireless communication system according to claim 3, wherein:
the mobile personal computer and the television is provided with a transmission/reception antenna respectively.

5. The wireless communication system according to claim 1, wherein:
the first and second communication terminals perform the wireless communication based upon communication standards of wireless LAN and PAN.

6. A communication terminal, comprising:
a wireless communication section that performs wireless communication with at least two different wireless communication methods;
a recognition section that recognizes a communication state of the wireless communication in each of at least the two different wireless communication methods with another communication terminal; and
a selection section that selects a wireless communication method with a higher communication rate out of at least the two different wireless communication methods.

7. The communication terminal according to claim 6, wherein:
the wireless communication section, comprises:
a first wireless communication section that performs the wireless communication based upon a communication standard of wireless LAN as one of at least the two different wireless communication methods; and
a second wireless communication section that performs the wireless communication based upon a communication standard of PAN as the other.

8. The communication terminal according to claim 6, wherein:
the recognition section notifies the another communication terminal that it is impossible to perform the wireless communication by the PAN.

9. The communication terminal according to claim 6, wherein:
the selection section selects an appropriate communication method out of at least the two different wireless communication methods based upon at least one of a communication distance and communication quality recognized by the recognition section.

10. The communication terminal according to claim 6, wherein:
the selection section selects an appropriate communication method out of at least the two different wireless communication methods based upon a distance between the communication terminal and the another communication terminal recognized by the recognition section.

11. A wireless communication system, comprising:
a first communication terminal;
a second communication terminal to perform wireless communication with the first communication terminal by at least two different wireless communication methods, wherein:
the first communication terminal, comprises:
a recognition section that recognizes a wireless communication state in each of at least the two different wireless communication methods with the second communication terminal, the recognition section comprising:
a communication quality recognition section that recognizes communication quality information of at least the two different wireless communication methods; and
a distance information recognition section that recognizes a distance information of one of at least the two different wireless communication methods; and
a selection section that receives the communication quality information and the distance information from the recognition section to select a communication method with a higher communication rate out of at least the two different communication methods, and wherein:
the first communication terminal performs the selected wireless communication method and the second communication terminal performs the wireless communication with the first communication terminal through the selected wireless communication method by the first communication terminal.

12. The wireless communication system according to claim 11, wherein:
the first communication terminal is a mobile communication terminal and the second communication terminal is a stationary communication terminal.

13. The wireless communication system according to claim 11, wherein:
the first communication terminal is a mobile personal computer and the second communication terminal is a television.

14. The wireless communication system according to claim 11, wherein:
the communication quality recognition section is connected to I/F for LAN and I/F for PAN to receive the communication quality information and the distance information; and
the distance information recognition section is connected to the I/F for PAN to receive the distance information.

15. A communication terminal, comprising:
a wireless communication section that performs wireless communication with at least two different wireless communication methods;
a recognition section that recognizes a communication state of the wireless communication in each of at least the two different wireless communication methods with another communication terminal,
the recognition section comprising:
a communication quality recognition section that recognizes communication quality information of at least the two different wireless communication methods; and
a distance information recognition section that recognizes a distance information of one of at least the two different wireless communication methods; and
a selection section that receives the communication quality information and the distance information from the recognition section to select a communication method with a higher communication rate out of at least the two different communication methods.

16. The communication terminal according to claim 15, wherein:
the wireless communication section, comprises:
a first wireless communication section that performs the wireless communication based upon a communication standard of wireless LAN as one of at least the two different wireless communication methods; and
a second wireless communication section that performs the wireless communication based upon a communication standard of PAN as the other.

17. The communication terminal according to claim 15, wherein:
the recognition section notifies the another communication terminal that it is impossible to perform the wireless communication by the PAN.

18. The communication terminal according to claim 15, wherein:
the selection section selects an appropriate communication method out of at least the two different wireless communication methods based upon at least one of a communication distance and communication quality recognized by the recognition section.

19. The communication terminal according to claim 15, wherein:
the selection section selects an appropriate communication method out of at least the two different wireless communication methods based upon a distance between the communication terminal and the another communication terminal recognized by the recognition section.

20. A wireless communication terminal, comprising:
a communication function section, comprising:
a wireless communication section that performs wireless communication with at least two different wireless communication methods;
a recognition section that recognizes a communication state of the wireless communication in each of at least the two different wireless communication methods with another communication terminal; and
a selection section that selects a wireless communication method with a higher communication rate out of at least the two different wireless communication methods; and
a communication apparatus main body detachably connected to the communication function main body, the communication apparatus main body, comprising:
a data storage section that stores data from the communication function section; and
a display section that displays the data.
